(19) United States
(12) Patent Application Publication
(10) Pub. No.: US 2017/0308622 A1
(43) Pub. Date: Oct. 26, 2017

(54) QUALITATIVE RATING SYSTEM FOR MULTI-COMPARTMENTED PRODUCTS RESPONSIVE TO SEARCH QUERIES

(71) Applicant: Marc C. Thornburgh, San Francisco, CA (US)

(72) Inventor: Marc C. Thornburgh, San Francisco, CA (US)

(21) Appl. No.: 15/488,506

(22) Filed: Apr. 16, 2017

Related U.S. Application Data
(60) Provisional application No. 62/326,223, filed on Apr. 22, 2016.

(51) Int. Cl. G06F 17/30; G06Q 50/16

(52) U.S. Cl. CPC G06F 17/30979; G06Q 50/163

(57) ABSTRACT

In embodiments, methods and apparatuses for reducing computer operations involved in responding to certain types of search queries are provided. In particular embodiments, which may be implemented utilizing a computer processor coupled to a memory, for example, facilitates gathering of qualitative parameters regarding features and/or amenities of a multi-compartmented product. The gathered qualitative parameters may be compared with features identified by a potential consumer, such as a potential renter of a vacation rental property, for example. Responsive to such comparison, a computer processor may quickly and efficiently provide candidate products having an increased likelihood of satisfying a consumer's need for a multi-compartmented product, such as a vacation rental property.

### CROSS-REFERENCE TO RELATED APPLICATIONS

This application claims the benefit of U.S. Provisional Patent Application No. 62/326,223 filed Apr. 22, 2016, entitled “Ambio Rating System for all lodging types, with optional Exchange Program,” which is incorporated herein by reference in its entirety.

### FIELD OF THE INVENTION

Embodiments of claimed subject matter may relate to search engines and, more particularly, to reducing computer processing and other resources involved in responding to certain types of search queries.

### BACKGROUND

Home rental marketing is expanding rapidly through the use of Airbnb™ and other online vacation property rental systems. Currently, there are no uniform on-line presentation, evaluation, and comparison tools for rental properties of any type, including single rooms, apartments, homes, and all other lodging properties for nightly, short, or extended stays. An on-line presentation, evaluation, and comparison tool, which may operate in association with a search engine, may reduce computer-processing resources consumed in response to submission of search queries by, for example, prospective renters, or other consumers.

### SUMMARY

The present invention is directed to methods, and devices and systems for carrying out the same, for reducing computer operations performed responsive to receipt of a search query. In an embodiment, the method may comprise parsing, via computer operations performed by a computer processor coupled to a memory, the received search query to obtain one or more desired first priority features (e.g. Must-Have features, high priority features) and one or more second priority features (e.g., Nice-to-Have features, high priority features) of a multi-compartmented product. A method may further comprise obtaining an entity type to indicate an expected number of users of the multi-compartmented product, wherein the computer processor may access a database storing parameters of candidate multi-compartmented products. The computer processor may additionally filter parameters of the candidate multi-compartmented products responsive to applying one of a plurality of sets of weighting parameters to features of the candidate multi-compartmented products stored in a database, the plurality of sets of weighting parameters based, at least in part, on the obtained entity type, the applying of the one of the plurality of sets of weighting parameters operating to reduce a number of candidate multi-compartmented products satisfying filtering criteria. The method may further comprise transmitting parameters corresponding to the reduced number of candidate multi-compartmented products satisfying the filtering criteria to a client-computing device.

In an embodiment, a method embodying features of the present invention for returning search results responsive to receipt of a search query for a multi-compartmented product, may comprise storing, in a database, one or more descriptive assets, dimensions of a plurality of individual compartments of the multi-compartmented product, a support-surface type, and an inhabitant capacity for one or more compartments of the multi-compartmented product. The method may further comprise storing, in a database, a plurality of features of the plurality of the individual compartments of the multi-compartmented product and storing, in a database, a feature rating of each of the individual compartments of the multi-compartmented product. In embodiments, a method may further comprise storing, in a database, a rating of one or more features external to the multi-compartmented product; and computing a composite rating for the multi-compartmented product based, at least in part, on a comparison of terms of the search query with the plurality of features of the one or more individual compartments of the multi-compartmented product, the feature rating of the individual compartments of the multi-compartmented product, and the ratings of features external to the multi-compartmented product. The method may further comprise transmitting, for presentation on a computer display, parameters of the multi-compartmented product responsive to the comparison of terms of the search query with the composite ratings that exceed a threshold.

In an embodiment, an apparatus may comprise a database to store a plurality of descriptive assets corresponding to portions of a plurality of multi-compartmented products and parameters of a plurality of individual compartments of the plurality of multi-compartmented products. An embodiment may further comprise a processor coupled to one or more memory devices to obtain parameters of a search query, the parameters of the search query to include a potential entity-type field, one or more relatively highly-desired features (e.g., first priority features), one or more relatively less highly-desired features (e.g., second priority features). In embodiments, the processor may operate to utilize a first weighting model responsive to receipt of a first entity-type entered and/or input into the potential entity-type field and to utilize a second weighting model responsive to receipt of a second entity-type entered and/or input into the potential entity-type field. In embodiments, first priority features may correspond to “Must-Have” features, and may be weighted significantly greater than second priority features, which may correspond to “Nice-to-Have” features. Embodiments may additionally perform comparisons, utilizing the first weighting model or the second weighting model, among a plurality of multi-compartmented products having time-dependent availability and returning one or more candidate multi-compartmented products, responsive to receipt of the search query, that best match the one or more first priority features and the one or more second priority features.

It should be understood that the aforementioned implementations are merely example implementations, and that claimed subject matter is not necessarily limited to any particular aspect of these example implementations.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a flowchart for a method for generating search results responsive to receipt of a search query for a multi-compartmented product, according to an embodiment.

FIG. 2 is a schematic block diagram of an apparatus and client device for generating search results responsive to receipt of a search query for a multi-compartmented product according to an embodiment.

FIG. 3 is a flowchart for a method for returning search results responsive to receipt of a search query for a multi-compartmented product, according to an embodiment.

FIG. 4 shows the overview of an architecture for the system according to an embodiment.

FIG. 5 shows the web page, which permits property management companies (PMCs) to add, modify, manage, or remove their vacation property listings according to an embodiment.

FIG. 6 shows editing of the general property parameters for a vacation property listing according to an embodiment.

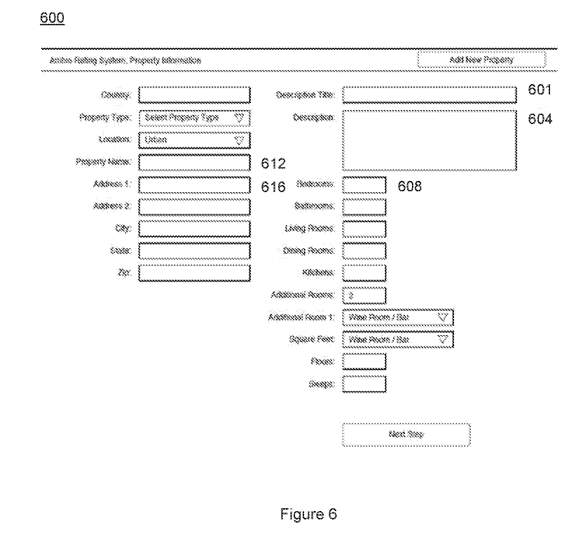

FIG. 7 shows editing of bedroom element details for a vacation property listing, including the searchable bedroom features according to an embodiment.

FIG. 8 shows the quality rating criteria used to determine the bedroom star rating. according to an embodiment

FIG. 9 shows the webpage where PMCs can indicate the vacation property features and area features around the vacation property location according to an embodiment.

FIG. 10 shows the initial search page for searching for available vacation property rental listings according to an embodiment.

FIG. 11 shows the available vacation property rental listings returned from the initial search, along with an area that permits users to narrow the search results, request Personalized Search, and/or select Must-Have and Nice-to-Have property features according to an embodiment.

FIG. 12 shows the Wishlist screen where users select Must-Have and Nice-to-Have rental property features according to an embodiment.

FIG. 13 shows the available vacation rental property listings returned by using the Personalized Search and Wishlist criteria entered by a user according to an embodiment.

FIG. 14 shows the vacation rental property listing results detail including the Personalized Property Score, overall property and room star ratings, and the matching Wishlist features according to an embodiment.

FIG. 15 shows the room details for the vacation rental property listing results including the detailed star rating for each of the key room elements according to an embodiment.

FIG. 16 shows how the personalized property score may be calculated according to an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DESCRIPTION OF THE DRAWINGS

Reference throughout this specification to “one example,” “one feature,” “one embodiment,” “an example,” “a feature,” or “an embodiment” means that a particular feature, structure, or characteristic described in connection with the feature, example or embodiment is included in at least one feature, example or embodiment of claimed subject matter. Thus, appearances of the phrase “in one example,” “an example,” “in one feature,” a feature,” “an embodiment,” or “in one embodiment” in various places throughout this specification are not necessarily all referring to the same feature, example, or embodiment. Furthermore, particular features, structures, or characteristics may be combined in one or more examples, features, or embodiments.

Particular nonlimiting embodiments of claimed subject matter may include the AMBIO Rating System (ARS), which comprises an aspect of the AMBIO software platform. In embodiments, the software platform facilitates parameter input, which may be utilized to generate ratings, which allow potential renters to view parameters of each vacation rental property through a quality-based lens and to search, filter and sort, and compare to find the best vacation rental property for their needs in the least amount of time, for example.

In particular embodiments, the software platform addresses a lack of uniform on-line presentation, evaluation, and comparison of all types of rental properties from single rooms, apartments, homes, and all other lodging properties for nightly, short, or extended stays, for example.

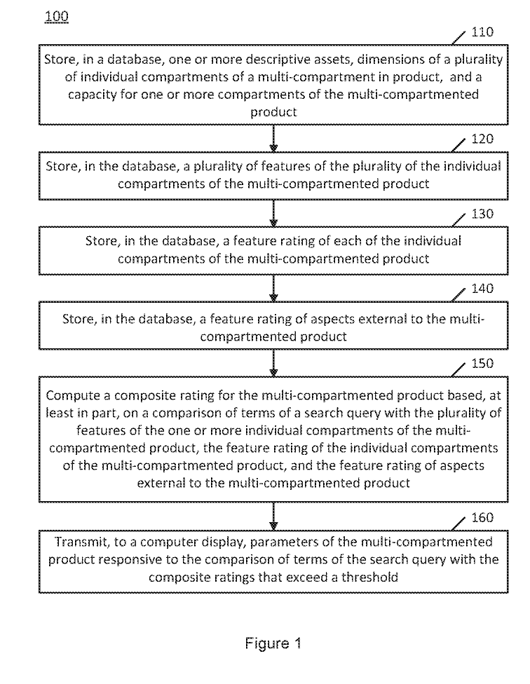

FIG. 1 is a flowchart for a method for generating search results responsive to receipt of a search query for a multi-compartmented product, according to an embodiment 100. In embodiments, a multi-compartmented product is defined as a structure having more than one substructures, rooms, or sections, accessible by way of a door, for accommodating one or more individuals. Thus, in particular embodiments, a multi-compartmented product may comprise a vacation rental property, such as a cabin, condominium, apartment, house, or multi-structure dwelling, although claimed subject matter is not limited in this respect. In particular embodiments, a multi-compartmented product may comprise time-dependent availability, as described herein. It should be appreciated that although in describing the drawings, exemplary embodiments of devices, systems, and methods embodying features of the present invention are directed to rental properties, the present invention is not limited to properties, rental or otherwise.

The method of FIG. 1 may begin at block 110, which may comprise storing, in a database, one or more descriptive assets, for example. In an embodiment, descriptive assets may comprise image assets, such as, for example, photographs, video clips, renditions, etc., which may visually or pictorially describe a multi-compartmented product, such as a vacation rental property. Block 110 may additionally comprise storing a description of a support-surface type, such as flooring, which may be described as carpeted, tiled, wood surfaced (such as by way of a maple, oak, or other type of wood flooring) and claimed subject matter is not limited in this respect. Block 110 may additionally comprise storing a capacity for one or more compartmented products of the multi-compartmented product. A capacity, in this context, refers to a number of inhabitants, occupants, tenants, or other type of users (which may include adults and/or children), for example, that may be accommodated by a compartment, such as a bedroom or living room, for example.

Block 120 may comprise storing, in the database, a plurality of features of the plurality of the individual compartments of the multi-compartmented product. Accordingly, block 120 may comprise storing features such as whether an individual compartment, such as a bedroom, comprises a window overlooking a body of water (e.g., beach, lake, river, etc.), type of sleeping arrangements of an individual compartment (single bed, bunk bed, premium mattress, etc.), closet and/or storage space, and a variety of additional amenities/features, and claimed subject matter is not limited in this regard. The method of FIG. 1 may continue at block 130, which may comprise storing, in the database, a rating of an individual compartment, such as an identifier in accordance with a scale comprising levels such as “poor,” “average,” “above average,” “good,” and “excellent,” just to name a few possible examples. In other embodiments, a feature rating may comprise a numerical scale, such as a scale comprising levels of “1,” “2,” “3,” “4,” “5,” “6,” “7,” “8,” “9,” and “10, for example. In other embodiments, a feature rating may comprise a scale comprising at least a first level (e.g., “good”) and at least a second level (e.g., “bad”), just as an example, and claimed subject matter is intended to embrace all manner of ratings to describe characteristics of an individual compartment of a multi-compartmented product.

The method of FIG. 1 may continue at block 140, which may comprise storing, in the database, one or more ratings of features external to the multi-compartmented product. Such feature ratings may comprise whether a vacation rental property, for example, provides access and/or use of a playground, a swimming pool, a basketball or tennis court, hiking trails, a beach, a lake (or other body of water), and claimed subject matter is not limited in this respect.

The method may continue at block 150, which may comprise computing or generating a composite rating for the multi-compartmented product based, at least in part, on a comparison of terms of a search query with the plurality of features of the one or more individual compartments of the multi-compartmented product. In an example embodiment, a possible search query term may comprise an “entity type,” which may relate to a potential renter or other type of temporary user. Nonlimiting examples of an entity type may correspond to an individual or group of individuals, a couple, a nuclear family, an extended family, and claimed subject matter is not limited in this respect.

In an embodiment, block 150 may operate to create a composite rating as a function of an entity type's likely interest in one or more of the plurality of features of one or more individual compartments. For example, in the event that an entity type corresponds to a married couple without accompanying children, a composite rating may exclude, or discount, a rating related to the presence of a playground, a rating of children's bedrooms, and/or other features that a married couple may be less likely to find appealing. In another example, an entity type corresponding to a nuclear family having multiple younger children may bring about a composite rating in which a premium is placed on a presence of a swimming pool, proximity to a beach, and so forth. Accordingly, in embodiments, a composite rating for a multi-compartmented product may comprise differing values based, at least in part, on an entity type, such as a potential renter, for example.

The method of FIG. 1 may continue at block 160, which may comprise transmitting, to a computer display, parameters of the multi-compartmented product responsive to the comparison of terms of the search query with the composite ratings that exceed a threshold. Accordingly, in an embodiment, block 160 may comprise transmitting a select number of multi-compartmented products, which may satisfy an entity type's desired rating of, for example, a vacation rental property.

In embodiments, a multi-compartmented product may comprise time-dependent availability. Accordingly, as part of a search query, a potential renter, for example, may enter a desired check-in date and a desired checkout date. However, in addition to time-dependent availability such as a date range, such as January 1 to January 15 of a particular year, time-dependent availability may additionally pertain to blocks comprising hours of the day, such as from 8:00 AM until 3:00 PM, blocks comprising entire weeks or months, or comprising any other suitable time increment.

In embodiments, a search query may comprise features of a multi-compartmented product, which an entity type, such as a potential renter, for example, may indicate as being relatively highly desirable, or even essential (e.g., a more heavily weighted “Must-Have” feature), as well as features indicated by an entity type as being desirable or preferred (e.g., a less heavily weighted “Nice-to-Have” feature). For example, an entity type corresponding to a married couple with accompanying children may indicate a high desirability (e.g. a “Must-Have”) for a vacation rental property to be adjacent to a beach. A married couple may additionally indicate that a vacation rental property is preferred or at least somewhat desirable to be close to desert hiking trails. Another embodiment, a “Must-Have” feature may be implemented as an mandatory feature utilizing, for example, a weight that is two times, three times, five times, 10 times that of a less highly-desirable “Nice-to-Have” feature. Accordingly, in embodiments, a search engine may compute a composite rating for a multi-compartmented product utilizing an increased weighting parameter for highly desirable (e.g., Must-Have) features relative to a weighting parameter for features identified by a potential renter as being preferred or only somewhat desirable (e.g., Nice-to-Have) features.

In embodiments, a database may additionally store one or more differences between a rating of a feature of one or more individual compartments of a multi-compartmented product and a rating assigned to the feature by previous renter, for example. In an embodiment, a feature of a master bedroom of a vacation rental, such as quality of a support surface (e.g., master bedroom carpet) may be rated relatively high. However, a previous entity, such as a previous renter, for example, may have found the bedroom carpet to be worn, stained, comprising a peculiar odor, or to exhibit one or more other undesirable qualities. Accordingly, the previous renter may have rated the feature (e.g., condition of master bedroom carpet) as relatively low. In particular embodiments, a database may store such discrepancies between ratings assigned to one or more features of a compartment of a multi-compartmented product. In embodiments, knowledge of such discrepancies may assess a potential consumer of a multi-compartmented product, such as a vacation rental property.

In certain embodiments, a database may store a user-specified threshold, which may pertain to a renter or other entity's desired level of features. Thus, a renter, for example, who favors accommodations that are more rustic, may specify, via a search query, a composite rating corresponding to a relatively low rated accommodation. However, a renter favoring higher-quality accommodations may specify, for example, highly rated accommodations.

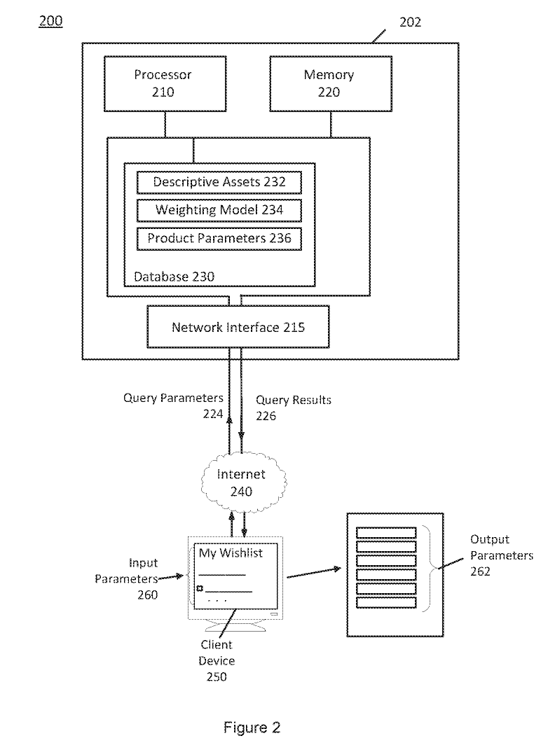

FIG. 2 is a schematic block diagram of an apparatus and client device for generating search results responsive to receipt of a search query for a multi-compartmented product according to an embodiment 200. In embodiments, a computing device 202 may operate to reduce a number of computer operations performed by a computer processor, such as processor 210, and may reduce operations performed by other portions of a computing device, by generating fewer candidate multi-compartmented products that satisfy filtering criteria identified via a search query. Accordingly, computing device 202 and client device 1550 of FIG. 2 may operate more efficiently and with an increased likelihood that a particular candidate multi-compartmented product satisfies a client-specified filtering criteria.

Operations performed by a computing device 202 may be initiated by obtaining parameters, such as input parameters 260, of the search query, entered by a user of client device 250. Parameters of the search query may comprise a potential entity-type, such as an individual traveling alone, a couple, couple traveling with accompanying children, for example. A search query may also comprise a Wishlist of Must-Have features, one or more Nice-to-Have features, or other types of features, for example.

Responsive to receipt of query parameters 224 by processor 210, the processor may access database 230, which may store a plurality of descriptive assets 232 corresponding to portions of the plurality of multi-compartment products. In embodiments, descriptive assets 232 store the database 230 may comprise captured images, such as photographs, video clips, multimedia files, etc., of a multi-compartment product. Parameters stored by database 230 may additionally comprise weighting model 234, which may operate to apply increased weights to features identified as Must-Have relative to features identified as Nice-to-Have, for example. Database 1530 may additionally store time-dependent availability of a multi-compartmented product, which may comprise calendar date ranges to indicate dates that a particular product, such as a vacation rental property, is available for inhabitation by, for example, a renter.

In embodiments, processor 210 may additionally apply weighting model 234 to candidate multi-compartment products, such as vacation rental properties, for example, based, at least in part, on a potential entity-type entry. For example, for an entity-type comprising an individual traveling alone, a weighting model that assigns weights to a condition of the various compartments, such as bedrooms other than a master bedroom (which may be unlikely to be of interest by an individual traveler) may be excluded from comparison operations. In another example, for an entity-type comprising a couple traveling with small children, a weighting model may be applied that more heavily weights access to a playground. Processor 210, operating utilizing computer code, instructions, or other logic fetched from memory 220, may perform comparisons of parameters of a plurality of multi-compartment products so as to obtain a best match, or a small group of best matches, of a multi-compartment product that satisfies Must-Have features and Nice-to-Have features. A best match, along with additional matches, may be transmitted via network interface 215 and Internet 240 in the form of query results 226 to a user of client device 250. In embodiments, a best match may be provided in the listing, such as a listing in descending order, as output parameters 262.

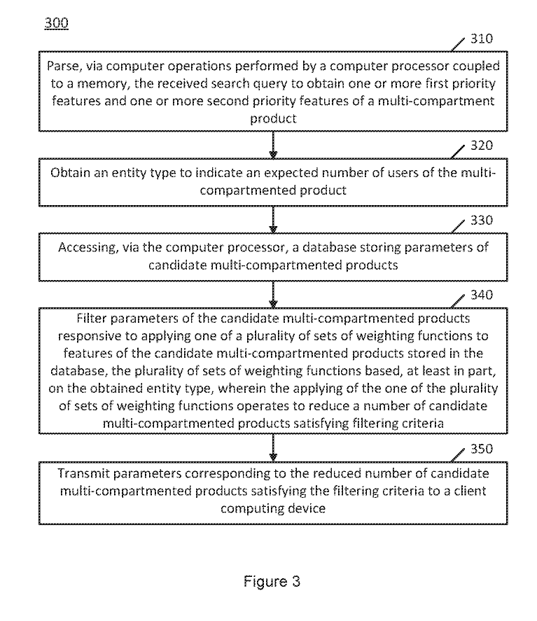

FIG. 3 is a flowchart for a method for returning search results responsive to receipt of a search query for a multi-compartmented product, according to an embodiment 300. Although the embodiment of FIG. 2 may be suitable for performing the method of FIG. 3 the method of FIG. 3 may be performed by numerous additional computer-processing systems, and claimed subject matter is not limited in this respect. The method of FIG. 3 may begin at block 310, which may comprise parsing, via computer operations performed by a computer processor coupled to a memory, received search queries to obtain one or more first-priority features and one or more second-priority features of a multi-compartment a product. In embodiments, first-priority features may refer to features identified in a search query as Must-Have features, while second-priority features may refer to features identified in the search query as Nice-to-Have features, for example.

Block 320 may comprise obtaining an entity type, such as via a submitted search query, to indicate an expected number of users of the multi-compartment product. In embodiments, a number of users may refer to a number of members of a family or other entity that may potentially rent, for example, a vacation rental property. At block 330, a computer processor may access a database storing parameters of candidate multi-compartment products. In embodiments, parameters may comprise descriptive assets, weighting models, ratings of individual compartments, ratings of features of individual compartments, previous renter-assigned ratings, and other parameters, and claimed subject matter is not limited in this respect.

At block 340, a computer processor, coupled to a memory via a communications bus may filter parameters of candidate multi-compartment products responsive to applying a set of weighting parameters, such as weighting parameters of a weighting model, to features of candidate multi-compartmented products stored in a database. In embodiments, sets of weighting parameters may be based, at least in part, on an entity type. In embodiments, applying a set of weighting parameters may operate to reduce the number of candidate multi-compartmented products satisfying filtering criteria. At block 350, the reduced number of candidate multi-compartmented products satisfying the filtering criteria may be transmitted to a client-computing device.

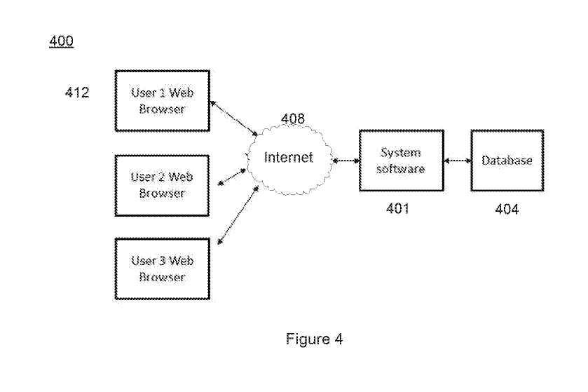

FIG. 4 shows an architecture of a software system according to an embodiment. The software system 400 may operate on a processor coupled to a memory of a computer system using a cloud based technology or on a single computer operating a back end software system 400 in conjunction with a web server in which the users of the system use a web browser 412 to access the software system using the Internet 408, for example. In an embodiment, the software system operates with a parameter storage system, such as a database, which may comprise a relational database 404. The computer system, which may execute instructions loaded from the software system may comprise a computer processing unit (CPU) including main memory, may be used to store temporary parameter and other executable instructions and variable parameters.

In particular embodiments, such as described with reference to FIG. 2, the software system, operating on at least one processor coupled to a memory, may generate search results utilizing executable code is stored in a memory. In embodiments, a software system may operate by fetching computer instructions from at least one memory of a computing device for execution on the computing device. Results of the execution of the fetched memory instructions may bring about improved and/or more efficient processing of search parameters pertaining to vacation rental properties. According to embodiments, a software system may be built using middleware software such as java, and JavaScript, which may thereby allow the software to process the parameters and store process parameters in a relational database. The web-based user interface, which interacts with the user may be built using modern programming languages such as HTML and JavaScript as well as Ruby, for example, through a web browser.

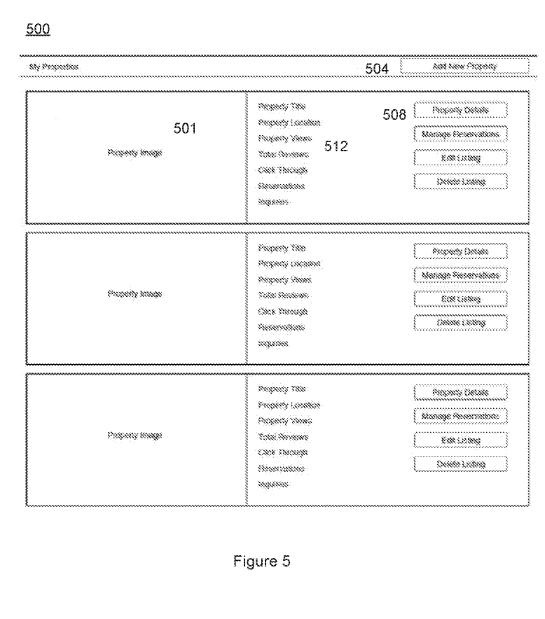

FIG. 5 shows an example listing of the multi-compartmented products, which, in the particular embodiment of an embodiment 500 may pertain, for example, to vacation rental properties. In an embodiment 500, parameters of a vacation rental property may be added 504 or edited 508 according to an embodiment 500. A user may observe the high-level view of the vacation property including viewing descriptive assets, such as a photo 501, total views 512, total reviews and reservations, for example.

FIG. 3 shows collection and display of specific parameters pertaining to rental properties in a uniform and comparable parameter format for a vacation rental property through a web based graphical user interface according to an embodiment 600. Property managing entities, such as PMCs may, by way of a user interface, enter a property address 616, title 601, property name 612, and description 604 for a vacation rental property. The vacation rental property may comprise a detailed list of rooms including the property features, for example. PMCs may enter the number of bedrooms 608, bathrooms, living room and dining room. Also, the vacation property comprises an assessment and photos of the outdoor living space.

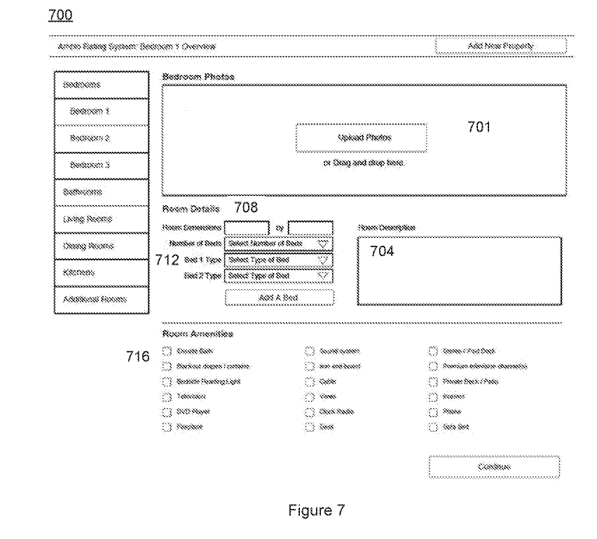

FIG. 7 shows a parameters capture screen for a bedroom having at least one photo 701 for the room, according to an embodiment 700. The bedroom also comprises a description 704, size or room dimensions 708, layout 712, and other features of the room. The bedroom parameters capture screen shows a list of features 716 that a PMC can indicate are offered in the room. The bedroom parameters capture may be representative of all other rooms being captured such as living room, dining room, kitchen, and bathroom, for example.

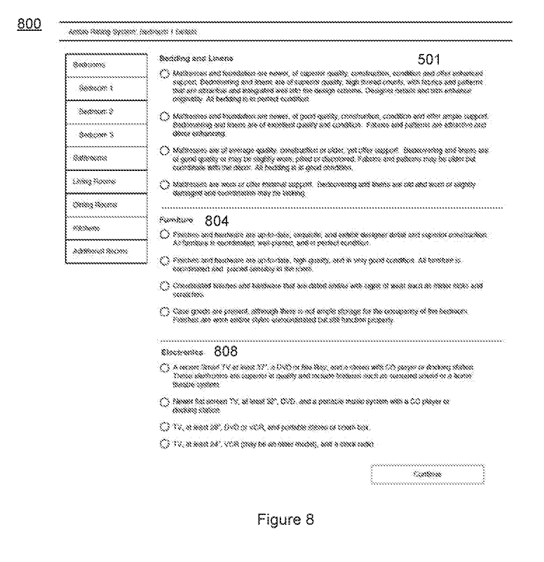

FIG. 8 shows the ratings of elements, such as key elements, for example, for the bedroom and conditions of the room in which two to five star rating may be provided in accordance with an embodiment 800. The bedroom rating input form allows PMCs to enter the rating for key elements, for example, in the room. In an embodiment, ratings are provided for bedding and linen 801, furniture 804 and electronics 808. The elements in the room are not limited to what is in FIG. 8, and claimed subject matter is not limited in this respect. Elements in each room of a property may be assessed and rated, for example, in accordance with the detailed criteria in the ARS ratings survey (see examples of detailed ARS criteria below).

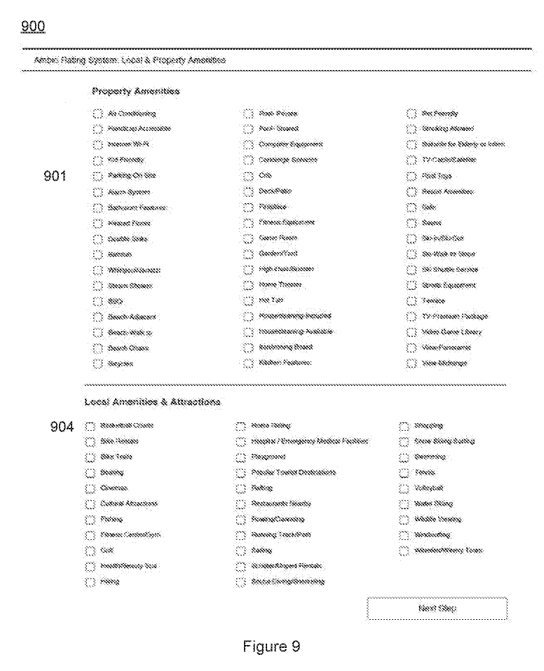

FIG. 9 shows the graphical user interface allowing the PMCs to capture the property features 901 and local and area features and attractions 904 according to an embodiment 900.

The ARS interactive software system may be synchronized across smartphone, iPad, and desktop so it can be used by PMCs in the office or in the field to create a property profile, which provides complete and robust property parameters and therefore, operating in conjunction with a computer processor coupled to a memory, may operate to sales time to potential renters.

Relational database 404 comprises a property table (of FIG. 4), which stores parameters related to number of bedrooms and number of bathrooms, for example. The database 404 may also store parameters related to the room table linked to the property table. The room table may store room attributes or features such as dimension of the room, and room descriptions. The room table may comprise other optional fields such as the number of beds and bed types for the bedroom and flooring type number of televisions along with the corresponding sizes, for example. The software system also may also comprise a features table, which may be linked to the property and the rooms, at least in particular embodiments. The features table may include the amenity description.

The software system may comprise a rating table linking to the property and room tables. A ratings table may store ratings provided by the PMCs. The rating may store the rating id, rating description, a flag indicating the type of rating (element, room, property, or guest) and the rating number as fields. The ratings table comprises the ratings for the various key elements in the rooms, average rating of all the elements in the room and the overall rating of the property. The ratings table would also store customer ratings for the whole property.

The software system may comprise a rental rates table and the rental reservation table. The rental rates table may be linked to the property table and contains the rental rates for the property over the year. The rental reservation table is linked to the property table comprises the dates the property is rented and are thus not available.

The software system populates the property table and the corresponding linked tables (room, features, rental rates tables) through the web browser based GUI by the PMCs.

The ARS allows potential renters to understand, evaluate, and compare how each vacation rental property matches their specific rental needs.

The system software provides PMCs with the software comprising quality rating definitions for all the important elements in the home and a list of check-off features for the renter's WishList filter.

PMCs provide the parameters for each participating vacation rental property and the software system merges the parameters into a standard format, which also allows for display of additional property parameters. The software system is capable of capturing and/or parsing the attributes of each room or area in the vacation rental property.

For example, a home containing a living room, two bedrooms, a bathroom, a dining room and a kitchen, each of the rooms are rated separately for the individual elements. FIG. 7 also shows a parameters capture screen for a bedroom. The system captures at least one photo 701 of the bedroom, room dimensions 708 and the number and type of beds in each bedroom. The system captures and stores the various bedroom features 716 (e.g., in-suite bath, television, fireplace, sound system, cable TV, etc.) through check marks indicating whether that bedroom comprises those features. Similarly, the software platform captures elements and attributes for living room, bathroom and kitchen. In this scenario, the software system captures the bathroom dimensions, flooring type (wood, stone, etc.) along with its features such as bathrobes, single/double sink, and full/half bath, washer/dryer, etc. For a living room, the system software captures the room dimension, floor type (wood, stone, etc.) and/or television along with various features (DVD Player Video Game Library Music library books, fireplace, etc.). For a dining room, the system software captures the room dimensions, and other options such as fireplace, adjacency to deck or patio, views, handicap access, open to living areas. For a kitchen, the system software captures the following options: gourmet kitchen, breakfast bar, espresso machine, ice maker, and wine cellar.

Using the software system 400 (FIG. 4), the PMC may capture the property features, features and area features associated with the property's location. FIG. 9 again shows the graphical user interface allowing the PMCs to capture the property features 901 and local and area features and attractions 904. Some of these features include but are not limited to shared pool, views, outdoor dining, adventure park, babysitting services, basketball courts, fishing, hiking, golf courses, motor boating, etc. The more area features which are captured for a given vacation property, the better the property will present itself to the users who are searching for a vacation home. The software system is capable of capturing the ratings for each room represented by the various standard elements. In a bedroom, the software system can capture the rating for the bedding and linens, furniture, electronics, lighting and floor coverings. For bedding and linens, the system can capture the high quality bedding and linen as 5 star and low quality bedding and linen as 2 star. An example description of the 5 star rating for bedding and linens is that mattresses and foundation are newer, of superior quality, and construction and bedcovering and linens are superior quality, high thread count, for example. An example description of a 2 star rating for bedding and linens may be that mattresses are worn or offer minimal support and bed coverings and linens are old and worn.

The ARS software system adds up the ratings for the various elements of the bedroom to come up with a cumulative rating for the bedroom. The software system stores element and cumulative ratings for each individual room of the property (each bedroom, living room, dining room, kitchen and bathrooms). The software system adds up the cumulative ratings of each room and averages the cumulative room ratings to tabulate the final rating of the entire property. In other words, the system software calculates the overall property rating based on the averaging of each room's rating. The system software also captures the user ratings and user reviews from the vacation home renters. The system software allows renters to create a targeted user review agreeing or disagreeing with specific element assessments made by the PMC or past guests. The system software allows user reviews to point out to the property owner and/or manager specific areas that need attention. These user ratings are displayed alongside of the PMC ratings, giving the potential renter an additional rating perspective on the property.

Examples of Detailed ARS Criteria:

LIVING ROOM: Furniture

‘5 Star’—Construction and upholstery is superior in quality and finishes are exquisite and unmarred. Upholstery is attractive, in tasteful colors and patterns, and is not stained, pilled or discolored. Attractive accent pieces and accessories enhance the décor and are well integrated.

‘4 Star’—Upholstery is of good quality with fresh, up-to-date patterns and colors. Construction is very good and in near new condition, with minimal signs of wear, such as very minor scratches or chips. Accent pieces and accessories coordinate.

‘3 Star’—Upholstery is of average quality and well maintained. Pieces may be older yet are durable and basic in construction. Laminate surfaces may be present. Finishes are showing wear and touch up or refinishing may be recommended. The overall coordination of décor may be lacking.

‘2 Star’—Upholstery and case goods are dated and uncoordinated. Furniture quality is modest and significant use is evident. Furniture placement may be functional but awkward; coordination of décor is lacking.

KITCHEN: Cabinets and Countertops

‘5 Star’—Cabinets, countertop and backsplash with custom designs or high-end finishes such as marble or granite. All finishes and hardware are in superior condition with no scratches, nicks, or gouges. Drawers and cabinets open with ease.

‘4 Star’—Cabinets, countertop and backsplash are up-to-date and attractive. Cabinets and hardware are good quality construction and in excellent condition. All materials are in good condition and enhance the décor of the kitchen. Drawers and cabinets open with ease.

‘3 Star’—Countertop, backsplash, and cabinet quality and finishes are older in appearance, but well maintained. Drawers and cabinets function properly and remain acceptable for use.

‘2 Star’—Countertop, backsplash, and cabinets are older and signs of wear are apparent, which may include chips, scratches, and stains. Construction, finishes, and cabinet hardware are dated, but remain acceptable for use.

### User Ratings and Reviews:

Cumulative User Ratings and Reviews are displayed on the standard format next to the PMC ratings, allowing the potential renter to see an additional assessment of specific elements. The ARS also allows guests to challenge specific ratings post-stay and to add comments about other nonrated elements and features of the property.

### Vacation Home Search and Sort System

The AMBIO Personalized Property Search (‘PS’) System is a unique search, filter, and sort platform designed to greatly reduce the amount of time a potential renter spends to find and confirm that a vacation rental property may be best matched to their needs.

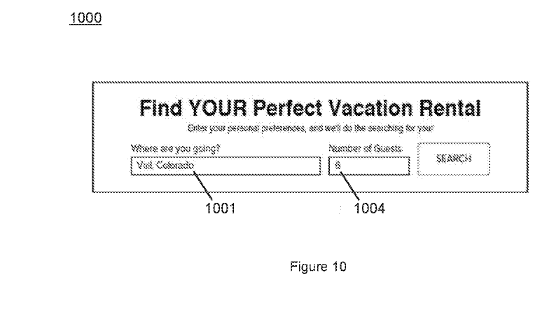

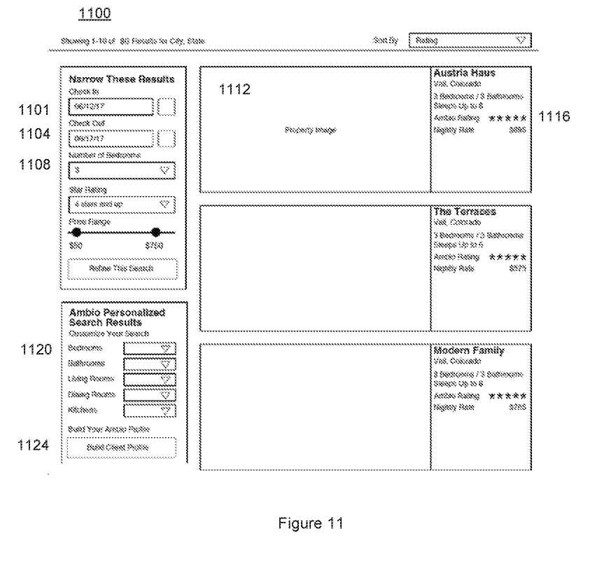

FIG. 10 shows an initial search screen for the system software in accordance with an embodiment 1000. The software system allows the users to search for and find vacation rental properties using criteria such as location 1001, and the number of guests 1004. FIG. 11 shows a resulting list of matching vacation rental properties and refined search options for vacation rental properties according to an embodiment 1100. The system software allows refinement of the initial search using check in date 1101, check out date 1104 and number of bedrooms 1108. This portion of the vacation rental property search may be standard with most vacation home search systems. The search results show a list of matching vacation rental properties including some thumbnail details about the property including photo 1112, property location, number of bedrooms and the AMBIO Star Rating for the property 1116.

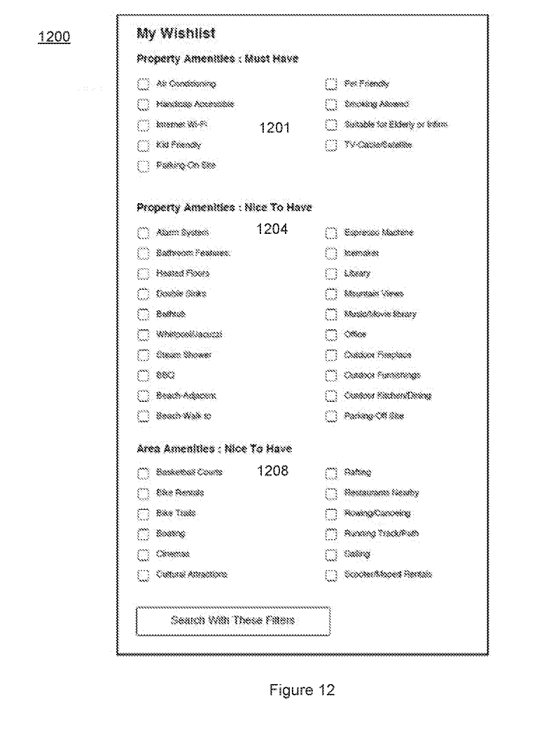

The AMBIO software system further allows for personalizing the search mechanisms, starting with the Wishlist. FIG. 12 shows a list of Must-Have and Nice-to-Have features a potential vacation renter can designate as desired features for their vacation property rental according to an embodiment 1200. The software system allows potential renters to search for Must-Have property features 1201 and Nice-to-Have features 1204, property, and area features 1208 for the vacation home. The Must-Have features are the features, which the vacationer requires as mandatory in the property they are searching for and are critical factors for deciding which vacation property to choose. The Nice-to-Have property features are features, which are highly desirable in the vacation home but are not critical for the selection.

The potential renter can select from the Wishlist their personal preferences of property location & types, room and property features and area amenities & attractions. Some property location and types available to select from are single family, hotel, apartment, cabin, condominium, lodge, etc. Some of the property features available in the listing of Must-Have features 1201 including air conditioning, handicap accessible, Wi-Fi, etc. Some in the Nice-to-Have features 1204 are alarm system, BBQ, beach-adjacent, beach-walk to, breakfast available, children's play area, etc. Some of the area amenities 1208 and attractions may comprise an adventure park, babysitting services, basketball courts, fishing, hiking, golf courses, motor boating, etc. Once the user selects the Must-Have and Nice-to-Have vacation rental property and area attributes and initiates the search, the user may be presented with a list of properties that match their Wishlist criteria.

The software system builds the search table to be used to search for available rental properties. The search table may be built using the property, rental rates and the rental reservation tables. The software system may comprise a post processing step after a rental property has been updated which updates the search table.

The software system performs a search for vacation rental properties using property location, check in date, check out date, and number of bedrooms. When performing the search in addition with the Wishlist personal preferences, the software system calculates how many of the Must-Have and Nice-to-Have features match each property and stores the numbers with each vacation property.

The system software saves the user's Wishlist of Must-Have and Nice-to-Have features with the user profile. After the search of the property, the software system goes through the list of matching property and matches each of the potential renter's Must-Have features with the amenities of the property including the room amenities. The system software would go through the whole list of property features and see if each one matches the Must-Have features. Once the matching Must-Have features are counted, the software system stores the matching Must-Have features with the vacation rental property data structure. The system software performs the same calculation for the Nice-to-Have features and stores the number of matching Nice-to-Have features with the vacation rental property.

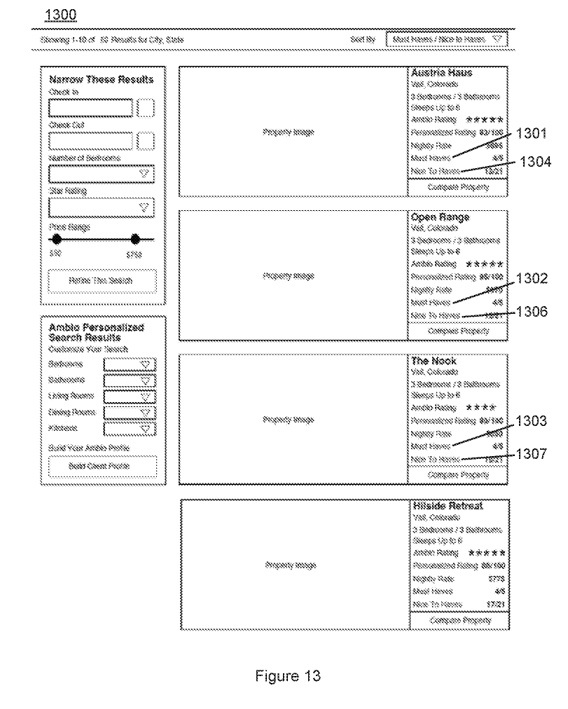

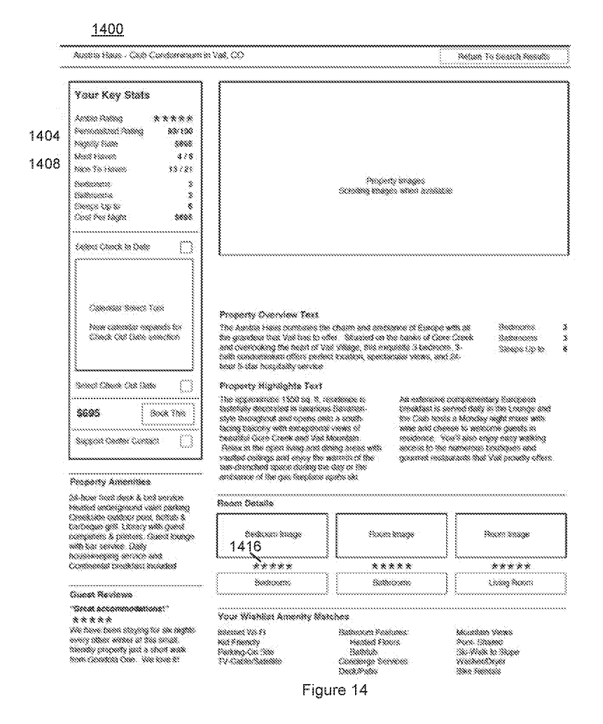

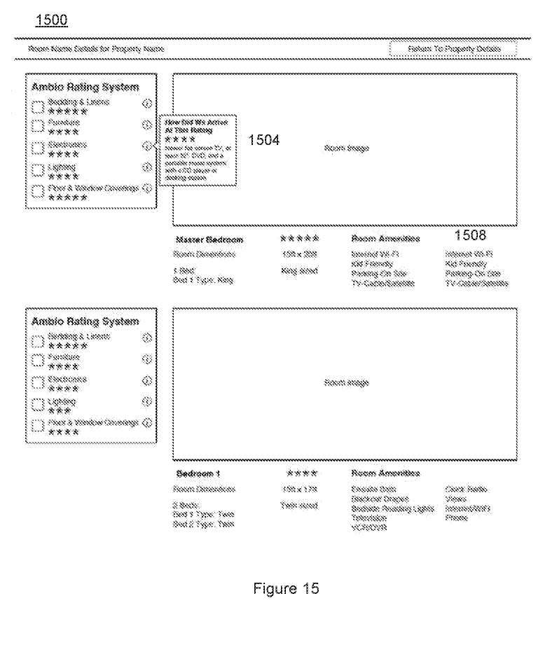

The vacation rental properties are then sorted and displayed in descending order by first the number of Must-Have features and second by the number of Nice-to-Have features. FIG. 13 (embodiment 1300) shows a vacation rental property listing result including the number of matching Must-Have features 1301 and Nice-to-Have features 1304. (Roll-over on the Must-Have/Nice-to-Have number to see specific matches.) As an example, the first property on the list might have 5 Must-Haves and 10 Nice-to-Have features 1304; the second on the list might have 5 features 1302 and 8 Nice-to-Have features 1306; the third property might have 4 Must-Have features 1303 and 12 Nice-to-Have features 1307, and so on. Search results display how many total properties including any Must-Have and Nice-to-Have feature matches. The software system calculates the number of total properties with Must-Have and Nice-to-Have feature matches by scanning each property and counting the number of properties with matching Must-Have and Nice-to-Have features. Each vacation property which matched the basic search criteria will list how many of the Must-Have and Nice-to-Have features match the vacation property. The software system can also sort by the number of Must-Have and Nice-to-Have features matched, but will also sort by ARS rating, Personalized Property Score, user ratings, price, etc. When navigating to the vacation rental property details, FIG. 14 (embodiment 1400) shows the personalized vacation property details titled “Your Key Stats”. The vacation property details screen show the number of matching Must-Have and Nice-to-Have features compared to the total number of Must-Have and Nice-to-Have features selected 1408. The vacation rental property details screen also shows the overall rating for the property from the ARS. Finally, the Key Stats show the Personalized Property Score. The vacation rental property details screen shows the calculated ratings 1416 for each of rooms in the property. After navigating to the room listing for a vacation rental property, FIG. 15 (embodiment 1500) shows the room listing screen with the ratings details for each of the elements in a room including an image 1504 and how the ratings roll up to the overall room rating. The room-listing screen also lists the features 1508 that are part of each room.

In another embodiment, the system software allows the user to create a Personalized Property Score (‘PPS’) using the weighted room mechanism. FIG. 11 again shows the search result of the vacation rental property list. The user ranks the importance of each room category 1120 for their specific vacation requirements and by selecting the button ‘Build Client Profiles’ 1124, the software produces a Personalized Property Score for each property using the ranking and the room ratings from the ARS as shown in FIG. 13. The user decides the importance of each room category for their specific travel requirements. In other words, the system software allows potential renters to designate the relative importance of each room/area and therefore understand through the Personalized Property Score the overall suitability of each vacation rental property for their specific needs or standards.

For example, if the renter will be travelling with children and grandchildren then for that vacation the kitchen, dining room and living room might be more important than the bedrooms or bathrooms; if the renter comprises a couple or if the renter does not intend to use the kitchen, then other room categories might be of higher priority and therefore get the higher weighting. The system allows up to 5 gradations between the most important and least important room categories of bedrooms, bathrooms, living room, dining room, kitchen, and outdoor features.

The software system uses room category priority ranking of #1 as 30 percent weight, #2 as 25, #3 as 20, #4 as 15, and #5 as 10 with the total room priority percentage as 100. The software system uses the ARS rating of each room category multiplied by the weight of each room provided by the user. For each property, the rating of a room category (one to five stars) may be multiplied by the appropriate percentage weight (10 to 30) assigned to the room category, all results are totaled and divided by 5 giving a Personalized Score of X out of 100. The system software may search for properties matching the standard search criteria such as property location, the number of people in the party, check in date, check out date and the number of bedrooms. The system software computes the personalized property score by using the property rate of each room and the user's room weightings for each room.

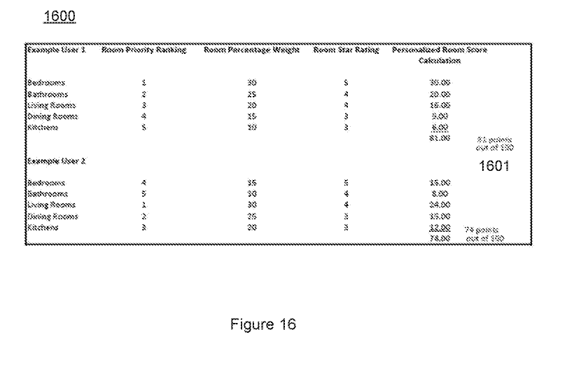

FIG. 13 shows how the Personalized Property Score may be calculated. In user example 1, bedrooms may comprise priority ranking of 1, bathrooms may comprise priority ranking of 2, living rooms may comprise priority ranking of 3, dining rooms may comprise priority ranking of 4 and kitchens may comprise priority ranking of 5. For the room rating, bedrooms may comprise a rating of 5, bathrooms may comprise a rating of 4, living rooms may comprise a rating of 4, dining rooms may comprise a rating of 3 and kitchen may comprise a rating of 3. The final Personalized Property Score may comprise a rating of 81 out of 100, for example. The ARS software calculates the room category ratings by averaging the ratings for each element in the room (bedding and linens, furniture and electronics) and then averaging the ratings for each of the room categories: bedrooms, living rooms, dining rooms, kitchens, and bathrooms using a data structure holding a matrix of all the rooms and the corresponding ratings for each of the elements in the rooms. The software system multiplies the result with the room percentage rate for each room category to get the personalized room score. The system aggregates the personalized room scores to get to the Personalized Property Score. FIG. 16 (embodiment 1600) again shows the vacation rental property listing with calculated personalized rating score 1601. When navigating to the property details, FIG. 14 shows the calculated Personalized Property Score 1404. The software system stores the Personalized Property Score with the rental property search results. The software system uses the cumulative ARS ratings stored for each of the room categories and applies the personalized importance or weighting to each room category, producing a Personalized Property Score 1404 for the renter.

All examples and conditional language recited herein are intended for educational purposes to aid the reader in understanding the principles of the claimed subject matter and the concepts contributed by the inventor to furthering the art, and are to be construed as being without limitation to such specifically recited examples and conditions. Moreover, all statements herein reciting principles, aspects, and embodiments of the claimed subject matter, as well as specific examples thereof, are intended to encompass both structural and functional equivalents hereof. Additionally, it is intended that such equivalents include both currently known equivalents as well as equivalents developed in the future, i.e., any elements developed that perform the same function, regardless of structure.

What is claimed is:

1. A method for returning search results responsive to receipt of a search query for a multi-compartmented product, comprising:
storing, in a database, one or more descriptive assets, dimensions of a plurality of individual compartments of the multi-compartmented product, and a capacity for one or more compartments of the multi-compartmented product;
storing, in the database, a plurality of features of the plurality of the individual compartments of the multi-compartmented product;
storing, in the database, a feature rating of each of the individual compartments of the multi-compartmented product;
storing, in the database, a rating of one or more features external to the multi-compartmented product;
computing a composite rating for the multi-compartmented product based, at least in part, on a comparison of terms of the search query with the plurality of features of the one or more individual compartments of the multi-compartmented product, the feature rating of the individual compartments of the multi-compartmented product, and the ratings of features external to the multi-compartmented product; and
transmitting, for presentation on a computer display, parameters of the multi-compartmented product responsive to the comparison of terms of the search query with the composite ratings that exceed a threshold.

2. The method of claim 1, wherein the multi-compartmented product comprises time-dependent availability.

3. The method of claim 2, wherein the time-dependent availability comprises calendar date ranges.

4. The method of claim 1, wherein the descriptive assets comprise one or more images of portions of the multi-compartmented product.

5. The method of claim 1, wherein the capacity comprises an inhabitant capacity for the multi-compartmented product.

6. The method of claim 5, wherein the inhabitant capacity for the one or more compartments of the multi-compartmented product comprises a count of individual sleeping accommodations of the one or more compartments.

7. The method of claim 1, wherein the computed rating comprises a rating between at least a first level and at least a second level.

8. The method of claim 1, wherein the search query comprises one or more first priority features and one or more second priority features of the multi-compartmented product, and wherein the computing the composite rating for the multi-compartmented product comprises applying an increased weighting parameter to the one or more first priority features in relation to weighting parameters applied to the one or more second priority features.

9. The method of claim 1, wherein the search for the multi-compartmented product comprises a potential renter-type field, the potential renter-type field operating to modify weighting parameters applied to the plurality of features of the individual compartments of the multi-compartmented product.

10. The method of claim 1, further comprising:
storing, in the database, one or more differences between a rating of a feature of one or more of the individual compartments of the multi-compartmented product and a previous renter-assigned rating of the feature of the one or more of the individual compartments of the multi-compartmented product.

11. The method of claim 10, wherein the previous renter assigned rating pertains to a condition of one or more individual compartments of the multi-compartmented product.

12. The method of claim 11, wherein the previous renter assigned rating pertains to a condition of the features external to the multi-compartmented product.

13. The method of claim 1, wherein the threshold comprises a user-specified threshold.

14. An apparatus, comprising:
a database to store a plurality of descriptive assets corresponding to portions of a plurality of multi-compartmented products and parameters of a plurality of individual compartments of the plurality of multi-compartmented products;
a processor coupled to one or more memory devices to obtain parameters of a search query, the parameters of the search query to include a potential entity-type field, one or more relatively highly-desired features, one or more less highly-desired features, the processor operating to:
utilize a first weighting model responsive to receipt of a first entity-type entered into the potential entity-type field and to utilize a second weighting model responsive to receipt of a second entity-type entered into the potential entity-type field, wherein one or more first priority features to be weighted greater than one or more second priority features;
perform comparisons, utilizing the first weighting model or the second weighting model, among a plurality of multi-compartmented products having time-dependent availability; and
return one or more candidate multi-compartmented products, responsive to receipt of the search query, that best match for the one or more first priority features and the one or more second priority features.

15. The apparatus of claim 14, wherein the descriptive assets comprise image assets corresponding to the portions of the plurality of multi-compartmented products.

16. The apparatus of claim 14, wherein the database comprises a time-dependent availability parameter corresponding to a calendar date range for each of the plurality of multi-compartmented products.

17. The apparatus of claim 16, wherein the processor operates to modify and entity-requested calendar date range to accommodate the time-dependent availability parameter for one or more of the plurality of multi-compartmented products.

18. The apparatus of claim 14, wherein the plurality of descriptive assets comprise photographic assets corresponding to portions of the plurality of multi-compartmented products.

19. The apparatus of claim 14, wherein the plurality of descriptive assets comprises an inhabitant capacity for the one or more compartments of the plurality of multi-compartmented products.

20. An apparatus, comprising:
means for storing a plurality of image assets corresponding to portions of a plurality of multi-compartmented products, parameters of a plurality of individual compartments of the plurality of multi-compartmented products, and an inhabitant capacity for the one or more compartments of the plurality of multi-compartmented products;
means for processing parameters of a received search query, the parameters of the received search query to include a potential renter-type field, one or more first priority features, one or more second priority features;
means for applying a first weighting model responsive to receipt of a first renter-type entered into the potential renter-type field;
means for applying a second weighting model responsive to receipt of a second renter-type entered into the potential renter-type field; and
means for assigning weights first priority features of the received search query higher than weights assigned for second priority features.

21. The apparatus of claim 20, further comprising:
means for performing comparisons, utilizing the first weighting model or the second weighting model, among a plurality of multi-compartmented products having time-dependent availability and returning one or more candidate multi-compartmented products, responsive to receipt of the search query, that best match the one or more first priority features and the one or more second priority features.

22. The apparatus of claim 20, wherein the means for processing the parameters of the received search query further comprise:
means for comparing time-dependent availability of the plurality of multi-compartmented products with a date range portion of the received search query.

23. The apparatus of claim 20, further comprising means for rating features of the plurality of individual compartments of the plurality of multi-compartmented products.

24. A method for reducing computer operations performed responsive to receipt of a search query, comprising:
parsing, via computer operations performed by a computer processor coupled to a memory, the received search query to obtain one or more desired first priority features and one or more second priority features of a multi-compartmented product;
obtaining an entity type to indicate an expected number of users of the multi-compartmented product;
the computer processor accessing a database storing parameters of candidate multi-compartmented products;
filtering parameters of the candidate multi-compartmented products responsive to applying one of a plurality of sets of weighting parameters to features of the candidate multi-compartmented products stored in the database, the plurality of sets of weighting parameters based, at least in part, on the obtained entity type, the applying of the one of the plurality of sets of weighting parameters operating to reduce a number of candidate multi-compartmented products satisfying filtering criteria; and
transmitting parameters corresponding to the reduced number of candidate multi-compartmented products satisfying the filtering criteria to a client-computing device.
